(19) United States
(12) Patent Application Publication
(10) Pub. No.: US 2004/0015517 A1
(43) Pub. Date: Jan. 22, 2004

(54) Method for editing and processing contents file and navigation information

(75) Inventors: Jeong-Jun Park, Seoul (KR); Sang-Seon Lee, Seoul (KR)

Correspondence Address: McGuire Woods LLP, Suite1800, 1750 Tysons Boulevard, McLean, VA, 22102-4215, US

(73) Assignee: iCUBE

(21) Appl. No.: 10/445,252

(22) Filed: May 27, 2003

(30) Foreign Application Priority Data
May 27, 2002 (KR) 2002-0029373

(51) Int. Cl. G06F 7/00

(52) U.S. Cl. 707/104.1

(57) ABSTRACT

A system for reproducing multiple contents, and a method for editing and processing a contents file and navigation information for providing intuitively recognizable search interfaces to a user. Additional information containing at least one title and at least one representative image associated with the title is received and the additional information is registered in a database. At least one contents file selected by the user as a file associated with the registered title is registered. If a contents file reading request is received through a wired/wireless communicator, the representative image associated with the title registered in the database is configured on a navigation screen, the configured navigation screen is converted in an MPEG2 I-frame format, and the converted navigation screen is transmitted to the contents file outputting stage. In response to the contents file outputting stage's command, there is accessed other navigation screen information to be subsequently reproduced after the navigation screen, or additional information, at least one contents file or file list information associated with each title configuring the other navigation screen information stored in the database or auxiliary storage unit. The accessed file or information is transmitted.

### CROSS REFERENCE TO RELATED APPLICATIONS

This application claims benefit of Korean Patent Application No. 2002-0029373, filed on May 27, 2002, which is hereby incorporated by reference for all purposes as if fully set forth herein.

### BACKGROUND OF THE INVENTION

1. Field of the Invention

The present invention relates to a system for reproducing multiple contents, and more particularly to a method for editing and processing a contents file and navigation information for a search interface from which users can intuitively recognize the contents of the file.

2. Description of the Related Art

Personal computers (PCs) have been wide spread and most households have at least one personal computer. People access various information through the PC and the Internet at home. The user of the PC receives various contents files, such as audio contents files (MP3, WAV, etc.), video contents files (AVI, MPEG, WMV, etc.), image contents files (JPEG, TIFF, BMP, etc.), text contents files (txt, doc, etc.), and others and stores them in the PC.

A multimedia system connected to the PC and an audio/visual (AV) system is configured at home such that the user can view high-quality images and listen to high-quality audio. However, there are many obstacles to overcome when outputting through the conventional AV system the contents files stored in PC collected from various sources. For example, image sizes, compression bit rates, frame rates, and other specifications of DivX, MPEG4 and MPEG2 files stored in the PC are all different. Therefore, the A/V system has to have each and every decoder for every type of contents files, in order to play back all those files.

Thus, a system or a method for converting various types of contents files into a format that can be decoded at the receiving end, may increase the utility of the multimedia system connected to the PC.

A conventional set-top box (STB) that can be coupled to the PC provides only file names belonging to a list of various contents files stored in the PC. In other words, when searching for the various types of contents files stored in the PC, the user cannot read information other than the file names. Thus, the user may not easily match the file names with the contents.

### SUMMARY OF THE INVENTION

The present invention addresses such problems as described above. The present invention provides a method for editing and processing a contents file and navigation information, which can edit and process the contents file and navigation information so that a user can intuitively recognize contents files stored in the storage device to be searched, and provide, to a user, the edited and processed contents file and navigation information in real time.

The present invention provides a method for editing and processing a contents file and navigation information, which can edit the navigation information so that a user can intuitively recognize information of contents to be stored in a recording medium, and can store the navigation information along with a corresponding contents file.

The present invention also provides a method for editing and processing a contents file and navigation information, which can automatically collect additional information of the contents file through the Internet and edit the collected information, and a storage device recording the information using the method.

Such advantages and features of the present invention can be accomplished by a method for editing and processing a contents file and navigation information executable on a computer, the method comprising the steps of:

receiving additional information containing at least one title and at least one representative image associated with the title and registering the additional information in a database;

registering at least one contents file selected by the user as a file associated with the registered title;

if a contents file reading request is received from a contents file receiving stage, configuring the representative image associated with the title registered in the database on a navigation screen, converting the configured navigation screen in an MPEG2 I-frame format, and transmitting the converted navigation screen to the contents file receiving stage; and

in response to the contents file outputting stage's command, accessing other navigation screen information to be subsequently reproduced after the navigation screen, or additional information, at least one contents file or file list information associated with each title configuring the other navigation screen information stored in the database or an auxiliary storage unit and transmitting the accessed file or information.

Thus, in the contents file receiving stage such as a set-top box (STB), an MPEG2 decoder decodes navigation screen information containing representative images transmitted from the computer. Then, the user can intuitively recognize each contents file through the representative image displayed on the navigation screen. Moreover, the user can read the additional information of each contents file by reading the additional information of the representative images displayed on the navigation screen.

In accordance with another aspect of the present invention, there is provided a method for editing and processing a contents file and navigation information executable on a computer, comprising the steps of:

receiving additional information containing at least one title and at least one representative image associated with the title and registering the additional information in a database;

registering at least one contents file selected by the user as a file associated with the registered title;

configuring at least one navigation screen containing the representative image associated with the at least one title selected by the user, converting the navigation screen in a moving picture experts group 2 (MPEG2) I-frame format and storing the converted navigation screen;

when a reproducing side reproduces the navigation screen, generating a meta data file containing access information for accessing other navigation screen information to be subsequently reproduced after the navigation screen, or additional information, at least one contents file or file list information associated with each title configuring the other navigation screen information; and

transmitting, to an optical disc recording device, the at least one contents file, file list information and additional information associated with the title selected by the user, the navigation screen information and the meta data file such that the optical disc recording device can record them on an optical disc.

Thus, the user of an audio/visual (AV) system equipped with an optical disc reproduction device can intuitively recognize contents files recorded on the optical disc through the navigation screen information. Moreover, the user can reproduce the additional information, file list information and contents files associated with each title through the navigation screen.

### BRIEF DESCRIPTION OF THE DRAWINGS

The present invention will be more clearly understood from the following detailed description taken in conjunction with the accompanying drawings.

FIG. 1 is a block diagram illustrating the configuration of a system for reproducing multiple contents in accordance with an example of the present invention.

FIG. 2 is a flowchart illustrating a method for editing and processing a contents file and navigation information in accordance with one embodiment of the present invention.

FIG. 3 is a flowchart illustrating another method for editing and processing the contents file and navigation information in accordance with another embodiment of the present invention.

FIG. 4 is a flowchart illustrating a method for transmitting the contents file and navigation information in real time in accordance with an embodiment of the present invention.

FIGS. 5, 6 and 7 are views illustrating exemplary editing screens displayed at a time of editing and processing the contents file and navigation information in accordance with an embodiment of the present invention.

FIGS. 8, 9, 10, 11, 12, 13, 14, and 15 are views illustrating exemplary screens displayed by a set-top box (STB) 200.

### DESCRIPTION OF THE PREFERRED EMBODIMENTS

Now, preferred embodiments of the present invention will be described in detail with reference to the drawings.

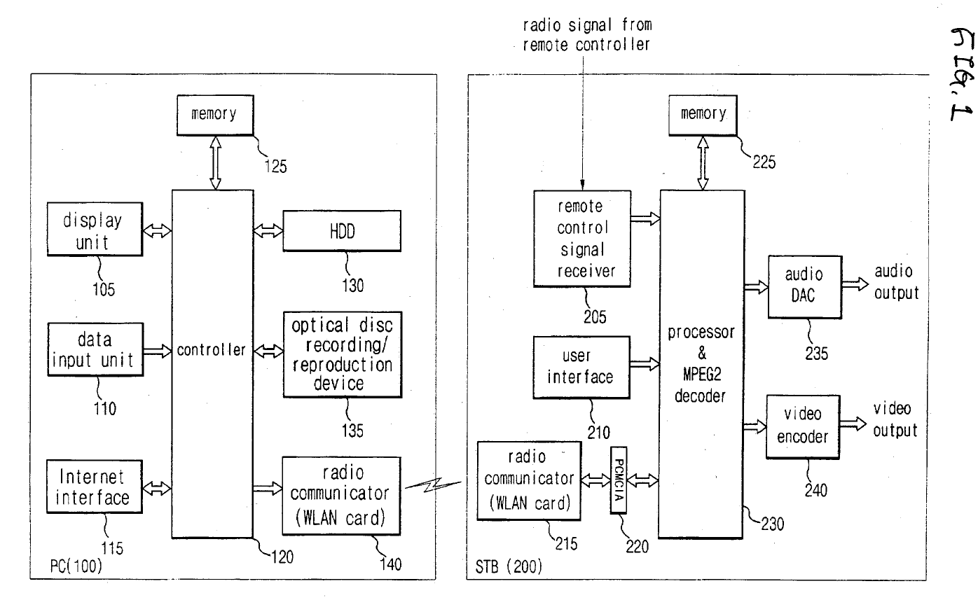

FIG. 1 is a block diagram illustrating the configuration of a system for reproducing multiple contents in accordance with an embodiment of the present invention. The contents reproduction system includes a personal computer (PC) 100 and a contents file outputting stage such as a set-top box (STB) 200. For reference, the contents file outputting stage can be a digital versatile disc (DVD) player being an optical disc reproduction device. Typically, the contents file outputting stage can be connected to an audio/visual (AV) system for externally displaying or outputting video, audio, text and image contents files.

The embodiment of the present invention is executed by a controller 120 of the PC 100. The user can generate and edit additional information containing a representative image corresponding to each contents file using the PC 100. The additional information allows the user at the set-top-box 200 side to easily search for a contents file and is used for generating navigation screen information.

Referring to FIG. 1, a display unit 105 can be any kind of display devices (e. g., a monitor or liquid crystal display (LCD)) of a conventional PC, and outputs various display data processed by a controller 120. A data input unit 110 is used for inputting additional information of contents files, and can be a typical input device, such as a keyboard or a mouse. An Internet interface 115 is a network connection unit such as a modem and interfaces data transmitted and received between an external network and the PC 100.

The controller 120 controls an entire operation of the PC 100 based on control program data stored in memory 125. For example, the controller 120 synthesizes representative images of respective titles selected by a user on a background screen according to the embodiment of the present invention in order to configure a navigation screen. It converts the navigation screen in a moving picture experts group 2 (MPEG2) I-frame format, stores the converted navigation screen, generates a meta data file containing access information for accessing at least one contents file of each title associated with the navigation screen, its additional information, and so on. Further, the controller 120 executes a web browser and connects the PC 100 to a server (being a CD database (CDDB)) with a uniform resource locator (URL) address programmed previously in order to retrieve desired additional information and provide it to the user.

The memory 125 stores not only application program data for implementing the present invention, but also various control program data for controlling an operation of the computer system. Further, the memory 125 stores a plurality of independent background screen data configuring the navigation screen in accordance with the present invention. For reference, the “background screen” can be optionally used for implementing the present invention, and can be defined as a screen consisting of a background of the navigation screen. In other words, the navigation screen can be configured by the background screen and representative images overlapped on the background screen in accordance with an embodiment of the present invention. An image, designated by the user and stored in a hard disk drive (HDD) 130 of an auxiliary storage device can be used as the background screen.

The HDD 130 stores various contents files selected by the user. The HDD 130 also has a database controlled by the controller 120. It is used for registering additional information corresponding to each title. An optical disc recording/reproduction device 135 is a typical compact disc-recordable (CD-R) or compact disc-rewritable (CD-RW) drive. The device 135 converts the contents files, list information and additional information associated with a title, the navigation screen information and the generated meta data file according to a CD format and records the converted file and information on a CD. Moreover, the device 135 reproduces an audio content file of the CD selected by the user.

A radio communicator (being a wireless local area network (WLAN) card) 140 communicates data with another radio communicator 215 provided in the STB 200. The radio communicator 140 transmits a data access command received from the STB 200 to the controller 120. The controller 120 retrieves the contents file or additional information, navigation screen information, and others. The controller 120 then converts them based on the WLAN communication protocol, and transmits them to the STB 200.

A configuration of the STB 200 for receiving and outputting the contents file or additional information, navigation screen information, etc. from the PC 100 will be described.

First, the STB 200 in accordance with an example of the present invention is equipped with a remote control signal receiver 205, which is a user interface. The remote control signal receiver 205 receives and decodes a radio signal sent from a remote controller according to the user operation. The decoded signal is sent to a processor & MPEG2 decoder 230. Another user interface 210 is a manipulation panel arranged on a front surface of the STB 200. The user interface 210 includes a plurality of buttons and indicator lamps. The user interface 210 outputs, to the processor & MPEG2 decoder 230, signals from the button manipulations by the user.

The radio communicator 215 transmits various access request signals from the processor & MPEG2 decoder 230 to the PC 100 through a personal computer memory card international association (PCMCIA) card 220, and transmits stream information, etc. sent from the PC 100 to the processor & MPEG2 decoder 230. The radio communicator 215 communicates data with the radio communicator 140 of the PC 100 using a widely used wireless communications protocol. One of the examples is an IEEE 802.11 protocol.

A memory 225 includes a flash memory and/or a dynamic random access memory (DRAM) including a synchronous dynamic random access memory (SDRAM). The memory 225 can store control program data for controlling the STB 200. The memory 225 can temporarily store stream data, etc. transmitted from the PC 100.

The processor & MPEG2 decoder 230 controls an entire operation of the STB 200 in response to the user's command from the remote control signal receiver 205 or the user interface 210. Moreover, the processor & MPEG2 decoder 230 decodes the stream information transmitted from the PC 100, i.e., a navigation screen and image contents file formatted as MPEG2 I-frame, according to an MPEG2 algorithm, and then outputs the decoded information. The processor & MPEG2 decoder 230 decodes a video contents file and an audio contents file and separately outputs the decoded video and audio contents files.

An audio digital analog converter (DAC) 235 converts audio data decoded by the processor & MPEG2 decoder 230 into analog data, and outputs them through the speakers. A video encoder 240 encodes decoded video contents file data into a composite video signal according to a national television system committee (NTSC) or phase alternation by line (PAL) system, and outputs the encoded video data to a video output device such as the TV.

The method for editing and processing a contents file and navigation information using the PC 100 provided in the multi-contents reproduction system will be described in detail.

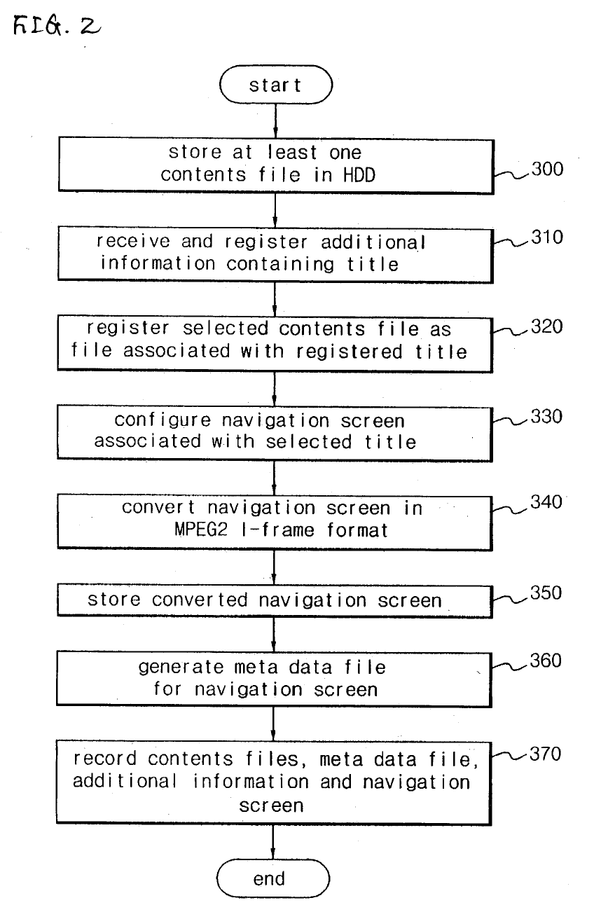

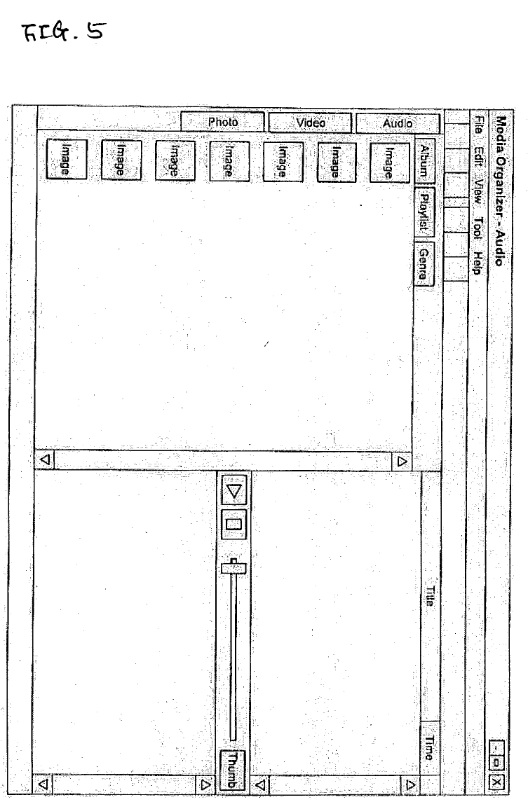

FIG. 2 is a flowchart illustrating the method for editing and processing the contents file and navigation information in accordance with one embodiment of the present invention; and FIGS. 5, 6, and 7 are views illustrating exemplary editing screens, when editing and processing the contents file and navigation information in accordance with an embodiment of the present invention.

Referring to FIG. 2, a plurality of contents files to be edited are stored in the HDD 130 of the PC 100 at step 300. For example, the above-described contents files include a video contents file (DivX, MPEG, etc.), audio contents file, text contents file and image contents file. When the contents files are downloaded from the Internet, the downloaded contents files can be stored in the HDD 130. Optionally, when the contents files are read or extracted from a recording medium such as a compact disc (CD), the extracted contents files can be stored in the HDD 130.

When the plurality of contents files are stored in the HDD 130, the embodiment of the present invention may allow the user to collect and edit contents files. An initial screen for file editing is shown in FIG. 5. Using this function, the user can edit representative thumbnail images and additional information associated with an audio contents file, a video contents file, a contents file of images such as photos, and a text contents file.

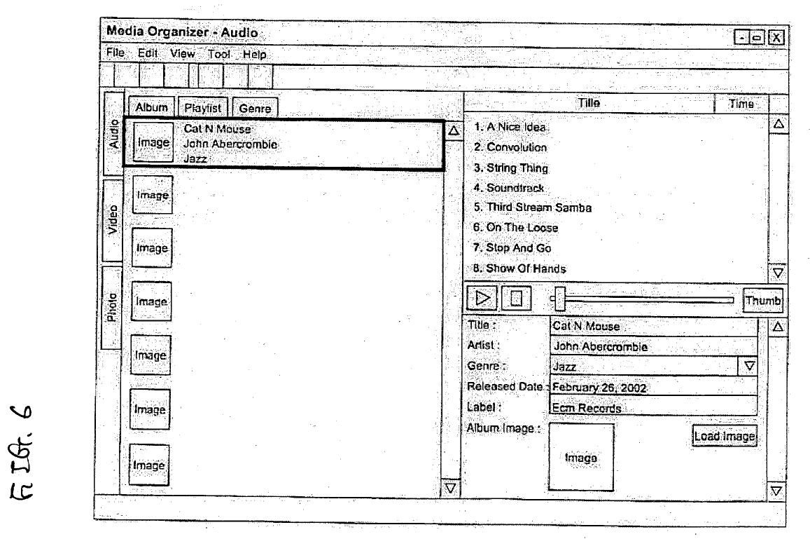

After selecting an audio, video or photo editing item at the editing screen of FIG. 5, the user enters additional information containing a title and a representative image corresponding to the title. If so, the controller 120 receives the additional information containing the title and the representative image corresponding to the title, and then stores such information to set up a database in the HDD 130 at step 310. FIG. 6 shows an editing screen corresponding to the case where the audio editing item is selected. The audio editing screen has categories of an album, a playlist and a genre. When the album category is selected, the user can input the additional information such as an album title (e.g., Cat N Mouse), an artist name, a genre, a release date, a label, etc. into input windows displayed on a lower portion of a right side in the screen. Further, the user can add a representative image as one of additional information items through which the user can intuitively recognize the album title using the STB 200 as the receiving side. The representative image can be added by a drag and drop operation for a corresponding image file contained in the image file list after the image file list stored in the HDD 130 is read. Further, the present invention supports a world wide web (WWW) search so that the user can obtain more additional information. That is, the embodiment of the present invention receives an Internet search keyword from the user or enables a web browser to search the WWW with a key of a contents file name. The user can add a desired representative image to a screen displayed on the web browser by drag and drop operation. An image loading button can be used when adding the representative image. The addition of the additional information through the web browser is applicable to not only an audio editing, but also all contents files containing a video, a digital image, etc.

As described above, if the user completes inputting additional information containing a title of a contents file to be edited, and a representative image and annotation information corresponding to the title, the user selects a desired contents file from among contents files stored in the HDD 130. At step 320, the selected file is registered as a contents file associated with the title registered at the above step 310. As shown in FIG. 6, a file list registered in names of specific titles is displayed to the user. For reference, only position information of files configuring the file list is organized in the database so that a corresponding file can be accessed later on.

Thus, the user can assign a title to a video contents file, an audio contents file, a text contents file, an image contents file or a group of files. The representative image and annotation information corresponding to each title can be additionally registered in the database. For reference, a well-known album function can be assigned to an audio contents file and a photo contents file. In other words, the additional information containing a title and a representative image corresponding to the title can be added to one video contents file, and the video contents file can be registered in the database. Moreover, the audio and photo contents files have album titles, and a representative image and annotation information corresponding to the album title can be registered as additional information. The representative image and annotation information corresponding to each audio or photo contents file belonging to an album can be added to the additional information. Here, the representative image enables the user to intuitively recognize the album title.

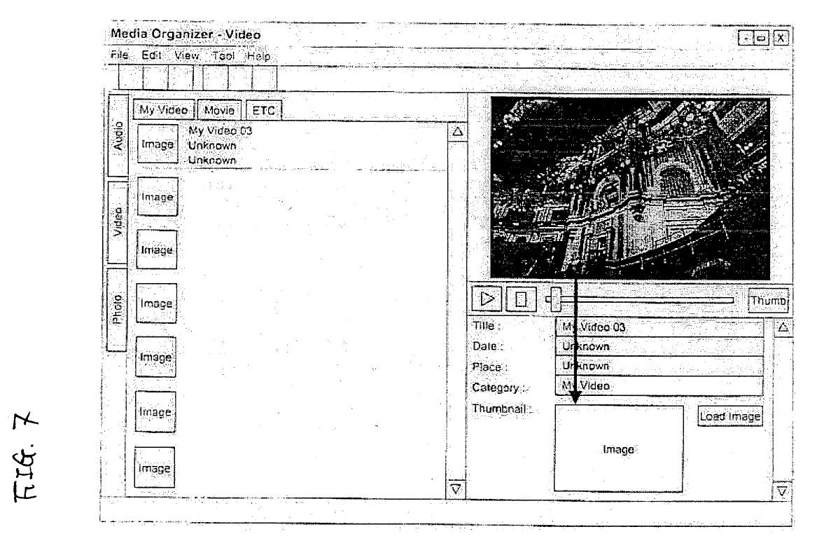

FIG. 7 shows an exemplary video-editing screen based on the user's selection. As an example, the video-editing screen includes the categories of “My video”, “Movie” and “ETC”. The user can add another category to the video-editing screen. FIG. 7 shows the exemplary video-editing screen of the case where one still picture accessed by the user's search or selection is selected as a representative image.

Completing the editing of contents files and additional information containing titles and representative images corresponding to the titles are stored in the HDD 130. In this state, a contents file to be edited by the user and a navigation screen for searching for the contents file are additionally generated, and the generated contents file and navigation screen are recorded on an optical disc. This operation will be described below.

First, after the user searches for a title database stored in the HDD 130, selects the title of a contents file to be edited and sends an optical disc recording command, the controller 120 configures a navigation screen corresponding to the title selected by the user at step 330. The navigation screen is created by synthesizing representative images on a previously stored background screen based on a batch message program (BMP) format. Of course, one navigation screen can be optionally created by only representative images without the background screen. The number of representative images that can be drawn on the navigation screen can be limited. Thus, if the number of titles registered by the user exceeds the number of representative images capable of being synthesized on the navigation screen, a plurality of navigation screens can be used. A subsequent navigation screen can be accessed in response to a subsequent navigation screen request from a reproducing side, i.e. STB 200.

As stated above, one or more navigation screens corresponding to the title selected by the user are created, the controller 120 converts the navigation screens in an MPEG2 I-frame format at step 340, and stores the converted navigation screens at step 350. The reason why the controller 120 converts the navigation screens is because an MPEG2 decoder provided in the STB 200 can decode the navigation screens based on the MPEG2 I-frame format. Accordingly, the PC 100 must convert not only the navigation screens, but also a contents file of images of photos in the MPEG2 I-frame format and transmit the converted screens and file so that the STB 200 can perform the decoding operation.

Upon accessing the navigation screens, the STB 200 being the reproducing side must recognize access information for accessing other navigation screen information to be reproduced subsequently, or additional information, at least one contents file or a file list corresponding to each title configuring the other navigation screen information. Thus, the controller 120 generates a meta data file including the access information for accessing the other navigation screen information to be reproduced subsequently, or the additional information, at least one contents file or file list corresponding to each title configuring the other navigation screen information. Since position information associated with the contents file corresponding to the representative image, the additional information, the subsequent navigation screen information, and others are included in the meta data file, the STB 200 can selectively perform a display operation and reproduce a corresponding contents file in response to inputs from the remote controller.

If the meta data file is completely generated, the controller 120 transmits, to the optical disc recording/reproduction device 135, at least one contents file, a file list, additional information and navigation screen information associated with the title selected by the user, and the generated meta data file. Then, the optical disc recording/reproduction device 135 records the contents file, meta data file, additional information and navigation screen information on a storage device, including an optical disc, according to a programmed CD format at step 370.

If a video contents file recorded on the optical disc (e.g., CD or DVD) is not a file compressed by an MPEG2 algorithm, an encoding operation for a corresponding file must be further performed according to the MPEG2 algorithm before the corresponding file is transmitted to the optical disc recording/reproduction device 135. Further, if the audio contents file is not an MPEG layer 3 (MP3) file, the audio contents file must be converted into the MP3 file at a time of transmitting the audio contents file. As described above, the encoding or converting operation must be performed so that the MPEG2 decoder can appropriately perform a decoding operation.

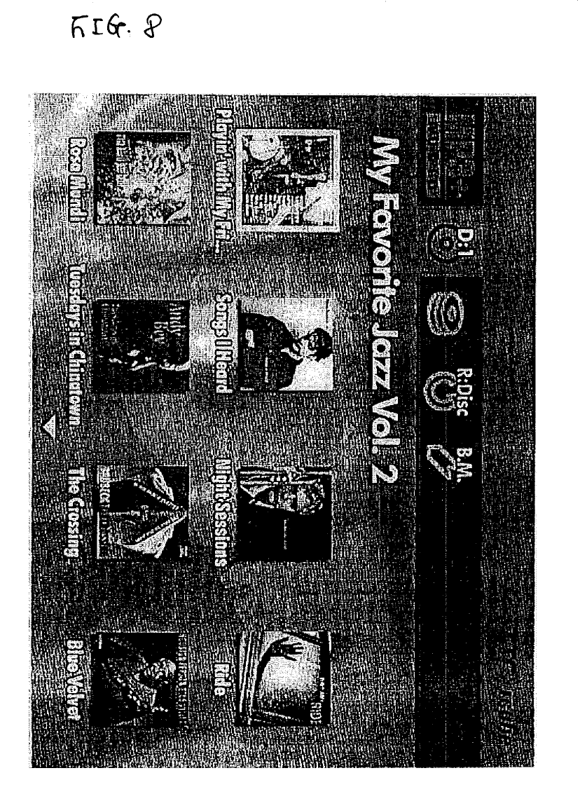

When a CD edited by the PC 100 is reproduced by the optical disc reproduction device such as a DVD player, the user can first access a navigation screen shown in FIG. 8.

FIGS. 8, 9, 10, 11, 12, 13, 14, and 15 show screens displayed on the STB 200 side in accordance with an embodiment of the present invention. Where an audio album is edited and created by the user, representative images corresponding to eight albums are synthesized on the navigation screen as shown in FIG. 8. An album title is given to each representative image. Upon reproducing the CD or making a navigation screen reading request, the user can intuitively recognize the information of contents files recorded on the CD since the navigation screen shown in FIG. 8 can be viewed through the display unit.

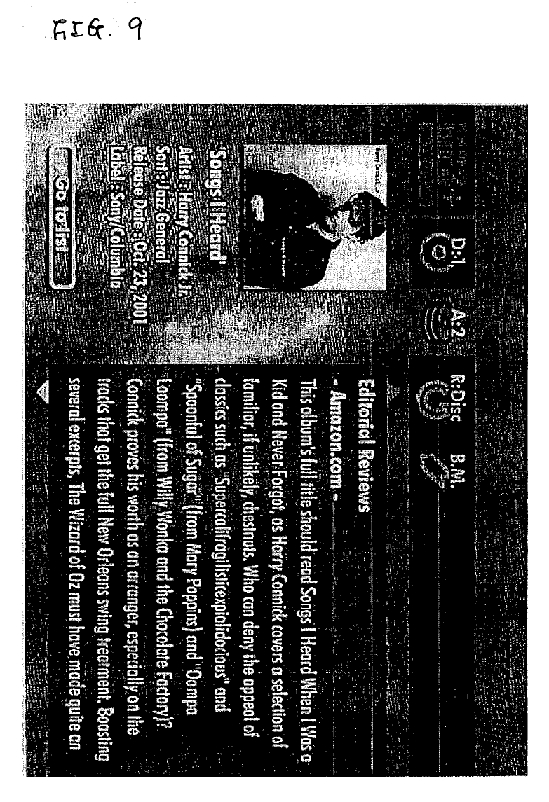

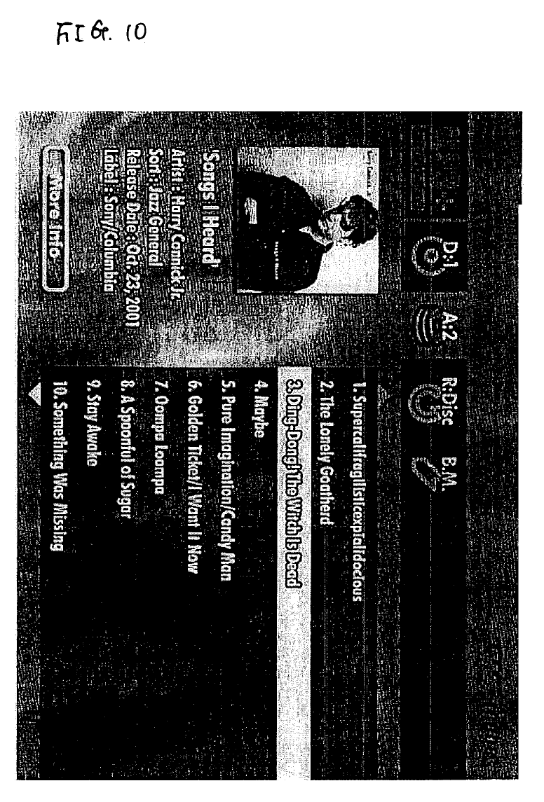

If the user has selected the second album having an album title “Songs I Heard” on the navigation screen as shown in FIG. 8, the DVD player's controller being a contents file outputting stage refers to the meta data file, accesses additional information of the selected album, and outputs the retrieved additional information. Then, the additional information is displayed on an exemplary screen as shown in FIG. 9. Thus, the user can view the additional information such as a genre, release date, artist name, label, etc. associated with the album “Songs I Heard”, and can receive an additional description of the album as another additional information item. Further, if the user selects a “Go to List” button shown in FIG. 9 to view a list of audio contents files recorded in the album, the user can read the list of audio contents files as shown in FIG. 10. The list of audio contents files can be accessed based on the access information found in a corresponding meta data file.

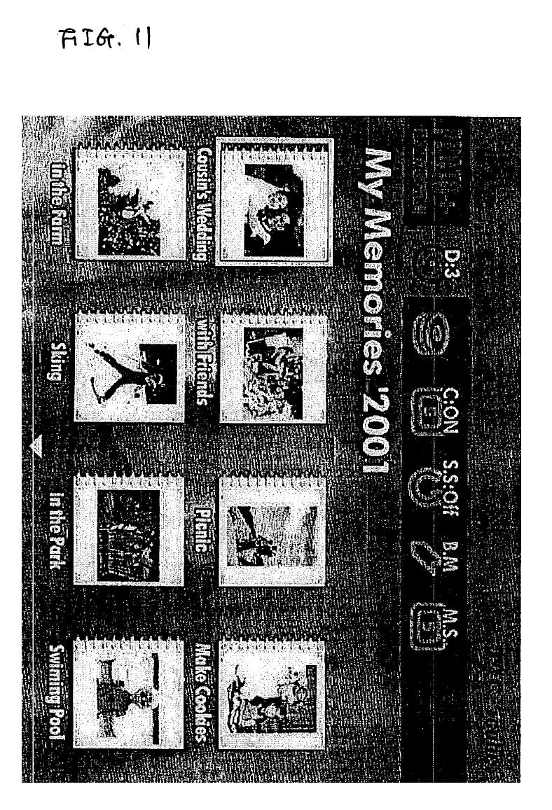

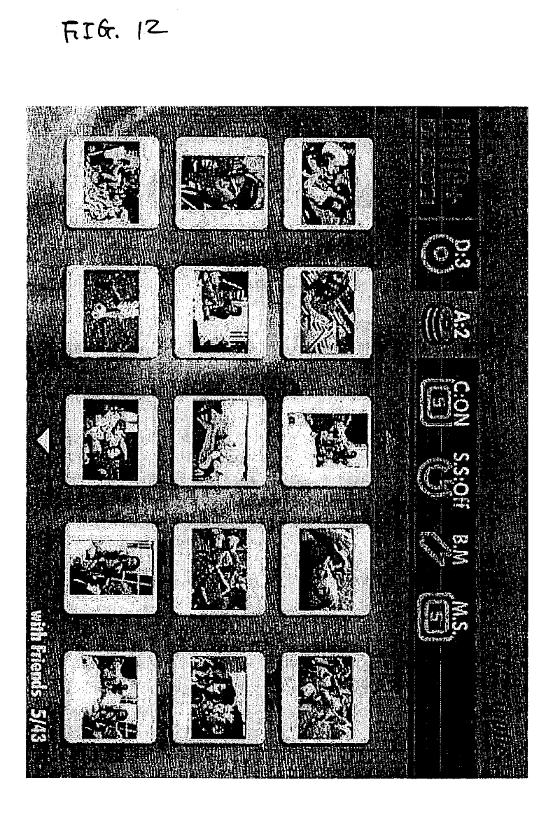

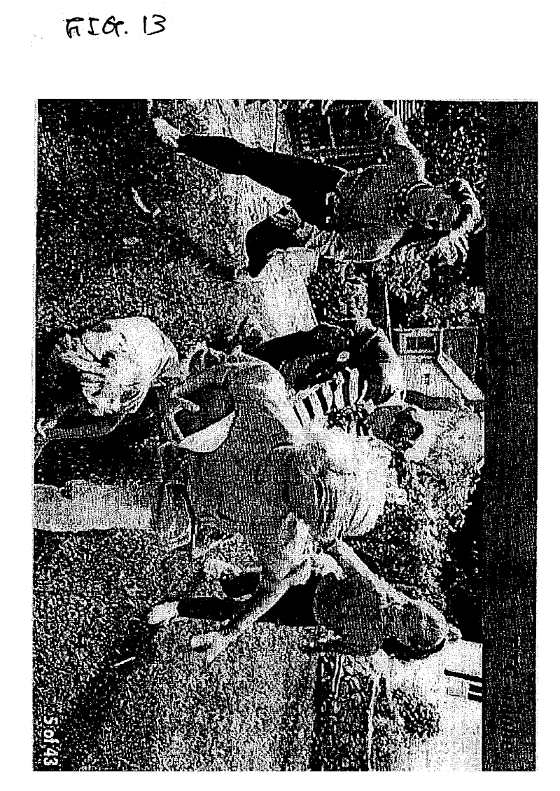

FIG. 11 shows an example of a navigation screen where a still picture indicates a picture album. The navigation screen includes eight album titles and their representative images. If a “with Friends” album is selected from the navigation screen, a plurality of image contents files recorded in the album are displayed as shown in FIG. 12. If any one of the displayed image contents files is selected, a photo of a large screen as shown in FIG. 13 can be viewed. By requesting additional information of the selected photo, the additional information such as a place, date and additional description of the corresponding photo is displayed as overlapping on the screen. Sequential accesses to image contents files or additional information items can be accomplished on the basis of a corresponding meta data file.

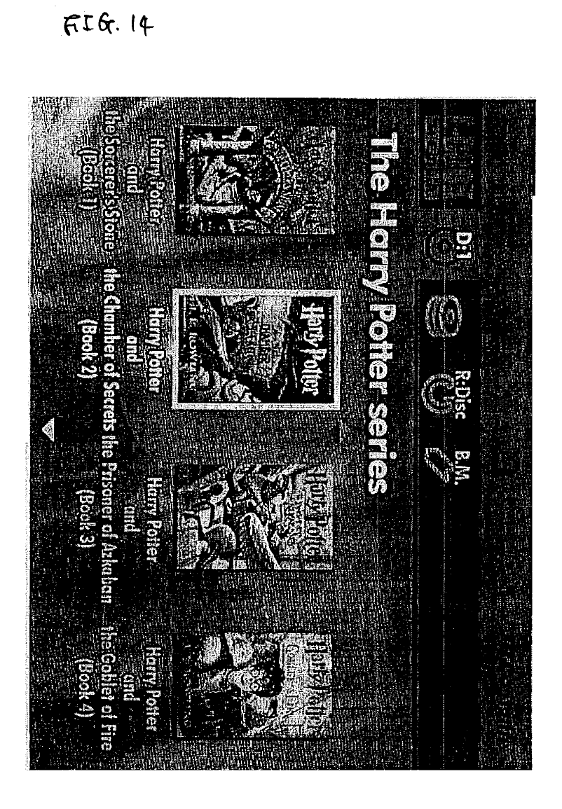

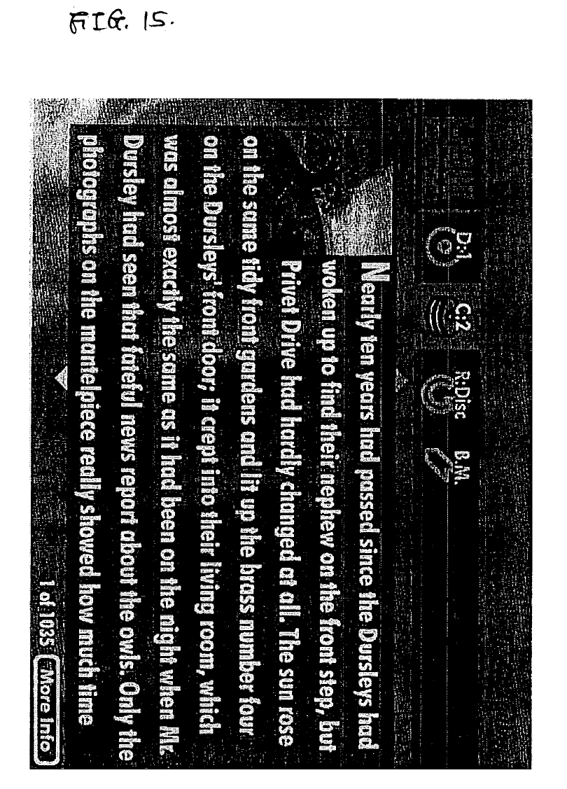

FIG. 14 shows an example of a screen where e-book files, which are one form of text contents, are created as albums. In FIG. 14, the screen for the text contents albums displays four representative images. Where each representative image is selected, text contents associated with the selected image are reproduced and displayed as shown in FIG. 15.

In accordance with the present invention, the user of the reproducing side can easily access a corresponding contents file or additional information with intuitively recognizing a list of contents files recorded on an optical disc. Since the PC 100 converts files of various formats into a format that can be decoded by the reproducing side, the reproducing side can reproduce all format files of the optical disc recorded by the PC 100 without additionally requiring separate decoding hardware or software at the reproducing side.

In addition to the above described method for inputting the additional information associated with each title, such additional information can be automatically collected and inputted through the following method.

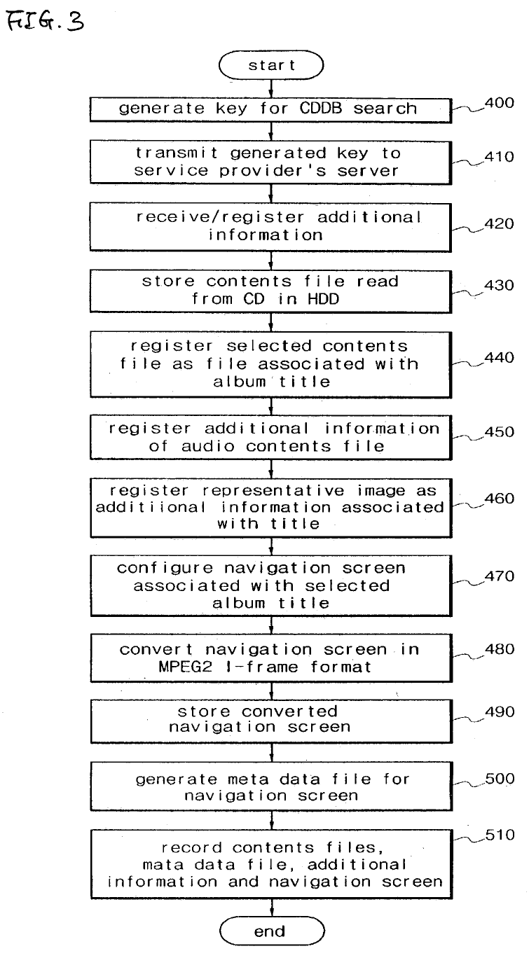

FIG. 3 is a flowchart illustrating another method for editing and processing the contents file and navigation information in accordance with another embodiment of the present invention. The flowchart illustrates that a contents file is extracted from a CD, the extracted contents file is used for editing a contents file, and additional information of the extracted contents file is automatically collected through the WWW searching.

Referring to FIG. 3, if the collection of the additional information using a CD database (CDDB) selection button is requested, the controller 120 generates a key for an optical disc DB search using a table of contents (TOC) of the optical disc loaded on the optical disc recording/reproduction device 135 at step 400. The key generation can use an address indicating a start sector of each track. When the start sector address indicates “183 10240 26570 46485 61753 85878 93070 112628 132215 146345 154265 158965 165283 184433 195183 223158”, the controller 120 combines the number of CD tracks and values generated after multiplying a start sector address value of each track by a predetermined number and dividing the multiplied address value by another predetermined number in order to generate a key having a character string of “0F+1A+3A+5F+1A+42+23+61+12”. Once generating the key for the additional information search, the controller 120 uses the web browser and connects to a CDDB service provider's server, of which uniform resource locator (URL) address has been already stored. The controller 120 requests the connected CDDB service provider's server to transmit additional information associated with the optical disc by transmitting the generated key to the server at step 410. In response to the request, the server transmits the additional information (e.g., a label, a release date, etc.) with a tag. The embodiment of the present invention can analyze the additional information using the tag. Items of the additional information transmitted from the server are inputted into additional information input windows shown in FIG. 6. The inputted information is registered as the additional information associated with each title at step 420. Of course, the additional information may include the title.

As stated above, if the additional information associated with the title has been completely registered, the user selects an audio contents file to be edited from a file list of the optical disc. If so, the controller 120 requests the optical disc recording/reproduction device to reproduce the audio contents file selected by the user, and stores in the HDD 130 the audio contents file transmitted from the optical disc recording/reproduction device in response to the request at step 440. Additional information containing representative images corresponding to respective files not described in FIG. 2 can be registered. The controller 120 receives additional information of the registered audio contents files selected by the user and registers the additional information at step 450. As described in FIG. 2, the controller 120 receives the representative image associated with the selected album title as the additional information and can register the representative image at step 460. Since the representative image for the album title is not supported by the CDDB, the user must take steps in registering the representative image.

As described above, the audio contents file to be edited is read from the loaded CD. Then, the retrieved audio contents file is stored in the HDD 130. Then, if the additional information of the contents file has been completely registered, the controller 120 performs the following operation as described in FIG. 2. Representative images associated with album titles are configured on one or more navigation screens at step 470. Then, the navigation screens are converted into the MPEG2 I-frame format and stored in the HDD 130 at steps 480 and 490. When the reproducing side 200 accesses the navigation screens associated with the album titles, a meta data file is generated. The meta data file contains access information for accessing other navigation screen information to be reproduced subsequently, or additional information on at least one contents file or the contents file associated with each title configuring the other navigation screen information. This is done at step 500. The contents file, additional information, navigation screen information and meta data file associated with each title selected by the user are transmitted to the optical disc recording/reproduction device 135. Finally, the optical disc recording/reproduction device 135 records the contents file, navigation information and additional information, etc. on the CD being the optical disc.

In accordance with another embodiment of the present invention, the user extracts the contents file from the CD, and stores the extracted contents file in the HDD 130. Additional information of a corresponding CD is automatically collected through the Internet using TOC information recorded in the CD so that the additional information can be generated.

The case where the contents files are recorded on the optical disc and reproduced has been exemplified. Next, an operation of transmitting navigation screens, contents files, etc. between the PC 100 and STB 200 in real time will be described.

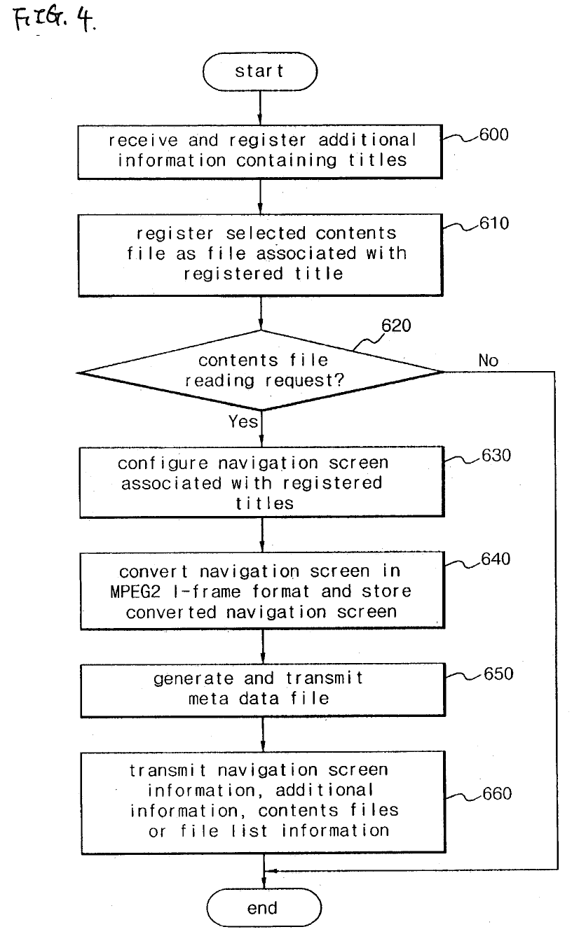

FIG. 4 is a flowchart illustrating a method for transmitting the contents file and navigation information between the PC 100 and STB 200 in real time in accordance with the present invention. In this embodiment, a plurality of contents files must be stored in the HDD 130, and additional information on contents files must be generated to be organized in the database.

That is, the user inputs additional information containing titles of contents files to be edited and representative images and annotation information associated with the titles, and then registers the additional information in the database at step 600. Then, the user selects a desired contents file from among the contents files stored in the HDD 130 and then registers the selected contents file as a file associated with a registered title at step 610. If the user makes an editedcontents file reading request through the remote controller when additional information items associated with the titles are registered in the HDD 130, the contents file reading request is transmitted to the radio communicator 140 of the PC 100 through the radio communicator 215 of the STB 200. Thus, the controller 120 can determine whether the contents file reading request exists.

Upon receiving the contents file reading request at step 620, the controller 120 configures, on a navigation screen, representative images corresponding to the titles registered in the database at step 630. At step 640, the controller 120 converts the representative images in an MPEG2 I-frame format, and stores the converted representative images. The controller 120 generates a meta data file needed for subsequently providing information selected from the navigation screen displayed through the STB 200 by the user and then transmits the generated meta data file to the STB 200 through the radio communicator 140 along with the stored navigation screen. For reference, the meta data file to be transmitted in real time can be configured by only identity (ID) information of the representative images contained in the navigation screen. That is, if the user selects an arbitrary representative image configuring the navigation screen, an ID corresponding to the selected representative image is fed back to the controller 120. Then, the controller 120 accesses a contents file, stored in the HDD 130, corresponding to the fed back ID, and transmits the accessed contents file. If an access to additional information of an arbitrary representative image is requested, an additional information access request tag is attached to the ID of a corresponding representative image and the ID is fed back to the controller 120, such that the controller 120 can access additional information of the corresponding representative image stored in the HDD 130, and transmit the accessed additional information. Of course, where another navigation screen subsequent to an arbitrary navigation screen is accessed, the access can be implemented through a feedback of ID information. The controller 120 can access and transmit a subsequent contents file or subsequent additional information without generating and transmitting the meta data file used for a real-time transmission. At this time, a position coordinate value associated with the user's selection on the navigation screen may be used. That is, if a shift button for shifting a display screen from one navigation screen to a subsequent navigation screen, an additional information open button, etc. can be displayed along with a representative image, a coordinate value on the screen selected by the user is fed back to the controller 120. Then, the information corresponding to the fed back coordinate value is accessed, and can be transmitted.

As described above, upon receiving feedback information for accessing subsequent information from the STB 200 after completely transmitting the meta data file along with the navigation screen, the controller 120 accesses subsequent navigation screen information, additional information corresponding to each title, a contents file associated with each title configuring the navigation screen, or file list information of respective titles stored in the HDD 130, and transmits the accessed information or file to the STB 200 at step 660.

As a result, the user of the STB 200 can sequentially access and view screens shown in FIGS. 9, 10, 12, 13 and 15 as subsequent navigation screens.

In accordance with the present invention, the user of the STB 200 can receive titles of contents files edited and registered by the PC 100 and read the received title, and intuitively recognize the files through representative images. The reproducing side such as the STB 200 can receive and output various types of contents files capable of being reproduced by the PC 100 without adding separate hardware or software for decoding for the files.

As apparent from the above description, the present invention enables a user to intuitively recognize contents files on a recording medium, since navigation information and various formats of contents files are recorded on the storage device.

Further, the present invention enables navigation information of contents files edited by the user to be transmitted in real time, such that the navigation information can be transmitted in real time in response to a request from a reproducing side receiving the real-time navigation information.

Furthermore, the present invention enables additional information of contents files to be automatically collected through the Internet and edited when navigation information is edited.

Although the preferred embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

What is claimed is:

1. A method for editing and processing a contents file and navigation information that can be executed by a computer, the computer being equipped with a communicator for communicating data with a contents file outputting stage and an auxiliary storage unit for storing contents files, the method comprising steps of:
receiving additional information containing at least one title and at least one representative image associated with the title and registering the additional information in a database;
registering a contents file selected by a user to be associated with the registered title;
if a contents file reading request is received through the communicator, configuring the representative image associated with the title registered in the database on a navigation screen, converting the configured navigation screen in a moving picture experts group 2 (MPEG2) I-frame format, and transmitting the converted navigation screen to the contents file outputting stage; and
in response to the contents file outputting stage's command, accessing other navigation screen information to be subsequently reproduced after the navigation screen, or additional information, at least one contents file or file list information associated with each title configuring the other navigation screen information stored in the database or auxiliary storage unit and transmitting the accessed file or information.

2. The method of claim 1, wherein the contents file comprises a video contents file, and
wherein the method further comprises a step of:
encoding the video contents file according to the MPEG2 algorithm when transmitting the video contents file, unless the video contents file is compressed by an MPEG2 algorithm.

3. The method of claim 1, wherein the contents file comprises an audio contents file, and
wherein the method further comprises a step of:
converting the audio contents file into the MP3 file when transmitting the audio contents file, unless the audio contents file is an MPEG layer 3(MP3) file.

4. The method of claim 2, wherein the contents file comprises an image contents file, and
wherein the method further comprises a step of:
converting the image contents file in an MPEG2 I-frame format when transmitting the image contents file, unless the contents file is the image contents file.

5. The method of claim 1, wherein the contents file comprises a text contents file.

6. The method of claim 1, wherein the navigation screen comprises one or more representative images synthesized on a background screen.

8. A method for editing and processing a contents file and navigation information that can be executed by a computer equipped with an auxiliary storage unit for storing a plurality of contents files, comprising steps of:
receiving additional information containing a title and a representative image associated with the title and registering the additional information in a database;
registering a contents file selected by the user to be associated with the registered title;
configuring a navigation screen containing the representative image associated with the at least one title selected by the user, converting the navigation screen in a moving picture experts group 2 (MPEG2) I-frame format and storing the converted navigation screen;
when a reproducing side reproduces the navigation screen, generating a meta data file containing access information for accessing other navigation screen information to be subsequently reproduced after the navigation screen, or additional information, at least one contents file and file list information associated with each title configuring the other navigation screen information; and
transmitting, to an optical disc recording device, the contents file, file list information and additional information associated with the title selected by the user, the navigation screen information and the meta data file such that the optical disc recording device can record them on an optical disc.

9. The method of claim 8, wherein the contents file comprises a video contents file, and
wherein the method further comprises a step of:
encoding the video contents file according to the MPEG2 algorithm when transmitting the video contents file, unless the video contents file is compressed by an MPEG2 algorithium.

10. The method of claim 8, wherein the contents file comprises an audio contents file, and
wherein the method further comprises a step of:
converting the audio contents file into the MP3 file at a time of transmitting the audio contents file, unless the audio contents file is an MPEG layer 3 (MP3) file.

11. The method of claim 9, wherein the contents file comprises an image contents file, and
wherein the method further comprises a step of:
converting the image contents file in the MPEG2 I-frame format when transmitting the image contents file, unless the contents file is the image contents file.

12. The method of claim 8, wherein the contents file comprises a text contents file.

13. The method of claim 8, wherein the navigation screen comprises one or more representative images synthesized on a background screen.

14. The method of claim 13, wherein the additional information comprises annotation information for additionally describing the contents file associated with the title or registered title.

15. A method for editing and processing a contents file and navigation information that can be executed by a computer equipped with an auxiliary storage unit for storing a plurality of contents files, comprising steps of:
receiving additional information containing at least one album title and at least one representative image associated with the album title and registering the additional information in a database;
registering contents files selected by the user as files associated with the registered album title;
receiving and registering additional information of the registered contents files;
configuring at least one navigation screen containing the representative image associated with the at least one album title selected by the user, converting the navigation screen in a moving picture experts group 2 (MPEG2) I-frame format and storing the converted navigation screen;
when a reproducing side reproduces the navigation screen, generating a meta data file access information for accessing other navigation screen information to be subsequently reproduced after the navigation screen, or additional information, at least one contents file or file list information associated with each album title configuring the other navigation screen information; and
transmitting, to an optical disc recording device, the at least one contents file, file list information and additional information associated with the album title selected by the user, the navigation screen information and the meta data file such that the optical disc recording device can record them on an optical disc.

16. The method of claim 15, wherein the contents file comprises an audio contents file.

17. The method of claim 16, further comprising steps of:
reading the audio contents file from the optical disc loaded in the optical disc recording reproducing device; and
storing the read audio contents file in the auxiliary storage unit.

18. The method of claim 16, further comprising a step of:
converting the audio contents file into the MP3 file at a time of transmitting the audio contents file, unless the audio contents file is an MPEG layer 3 (MP3) file.

19. The method of claim 15, wherein the contents file comprises an image contents file, and
wherein the method further comprises a step of:
converting the image contents file in the MPEG2 I-frame format at a time of transmitting the image contents file, unless the contents file is the image contents file.

20. A method for editing and processing a contents file and navigation information that can be executed by a computer equipped with an optical disc recording/reproduction device, comprising steps of:
generating a key for searching for a loaded optical disc's database (DB) using table of contents (TOC) information;
transmitting the key to an optical disc DB service provider's server and receiving additional information associated with the loaded optical disc;
registering the received additional information associated with the loaded optical disc as additional information of an album title;
reading an audio contents file selected by a user from the loaded optical disc and storing the audio contents file in a storage device;
registering the audio contents file selected by the user as a file associated with the registered album title;
receiving and registering additional information of the registered audio contents files;
registering a representative image associated with a selected album title as the additional information associated with the album title;
configuring the representative image on at least one navigation screen, converting the navigation screen in a moving picture experts group 2 (MPEG2) I-frame format and storing the converted navigation screen;
when a reproducing side reproduces the navigation screen, generating a meta data file containing access information for accessing other navigation screen information to be subsequently reproduced after the navigation screen, or additional information, at least one contents file or file list information associated with each album title configuring the other navigation screen information; and
transmitting, to the optical disc recording/reproduction device, the at least one contents file, file list information and additional information associated with the album title selected by the user, the navigation screen information and the meta data file such that the optical disc recording/reproduction device can record them on an optical disc.

21. The method of claim 20, further comprising a step of:
converting the audio contents file into the MP3 file at a time of transmitting the audio contents file, unless the audio contents file is an MPEG layer 3 (MP3) file.

22. An optical disc recording medium, comprising:
a plurality of contents files associated with at least one title;
navigation screen information containing additional information and a representative image associated with the at least one title; and
a meta data file for accessing the navigation screen information,
wherein the contents files, the navigation screen information and the meta data file are recorded in anticipation of user requests.
